(19) United States
(12) Patent Application Publication
(10) Pub. No.: US 2025/0173467 A1
(43) Pub. Date: May 29, 2025

(54) SYSTEMS, METHODS, AND APPARATUS FOR MEMORY DEVICE WITH DATA SECURITY PROTECTION

(71) Applicant: Samsung Electronics Co., Ltd., Suwon-si (KR)

(72) Inventors: Zongwang LI, Dublin, CA (US); Da ZHANG, Blacksburg, VA (US); Shuyi PEI, Santa Clara, CA (US); Rekha PITCHUMANI, Oak Hill, VA (US); Yang Seok KI, Palo Alto, CA (US)

(21) Appl. No.: 18/935,413

(22) Filed: Nov. 1, 2024

Related U.S. Application Data
(60) Provisional application No. 63/603,633, filed on Nov. 28, 2023.

(51) Int. Cl. G06F 21/78; G06F 21/60

(52) U.S. Cl. CPC G06F 21/78; G06F 21/602

(57) ABSTRACT

In some aspects, a device may include at least one circuit including an encryptor and a decryptor; memory media; and storage media, where the encryptor and decryptor are configured between the memory media and storage media; and the at least one circuit is configured to perform one or more operations including receiving at least a portion of data; encrypting, using the encryptor, the at least a portion of data as encrypted data; and storing, to the storage media, the encrypted data. In some aspects, the at least one circuit is further configured to perform one or more operations including receiving, from the storage media, the encrypted data; decrypting, using the decryptor, the encrypted data as decrypted data; and sending the decrypted data.

### REFERENCE TO RELATED APPLICATION

This application claims priority to, and the benefit of, U.S. Provisional Patent Application Ser. No. 63/603,633, filed on Nov. 28, 2023, which is incorporated by reference.

### TECHNICAL FIELD

This disclosure relates generally to memory devices, and more specifically to systems, methods, and apparatus for a memory device with data security protection.

### BACKGROUND

Generally, memory media (e.g., cache media) may be used to temporarily store data. To retain the data (e.g., allow for longer storage), the data may be written to storage media. In other words, if a host wants to retain temporarily stored data for longer storage, the data may be written from the memory media to the storage media.

The above information disclosed in this Background section is only for enhancement of understanding of the background of the invention and therefore it may contain information that does not constitute prior art.

### SUMMARY

In some aspects, the techniques described herein relate to a device including at least one circuit including an encryptor and a decryptor; memory media; and storage media, where the encryptor and decryptor are configured between the memory media and storage media; and the at least one circuit is configured to perform one or more operations including receiving at least a portion of data; encrypting, using the encryptor, the at least a portion of data as encrypted data; and storing, to the storage media, the encrypted data. In some aspects, the at least one circuit is further configured to perform one or more operations including receiving, from the storage media, the encrypted data; decrypting, using the decryptor, the encrypted data as decrypted data; and sending the decrypted data. In some aspects, the encryptor is a first encryptor; the decryptor is a first decryptor; the at least a portion of data is first data; the at least one circuit further includes a second encryptor and a second decryptor; and the at least one circuit is further configured to perform one or more operations including receiving second data; encrypting, using the second encryptor, the second data as second encrypted data; and storing, to the memory media, the second encrypted data. In some aspects, the at least one circuit is further configured to perform one or more operations including receiving, from the memory media, second encrypted data; encrypting, using the encryptor, the second encrypted data as third encrypted data; and storing, to the storage media, the third encrypted data. In some aspects, the encryptor is a first encryptor; the encrypted data is first encrypted data; the memory media is configured to receive second encrypted data from a second encryptor; and the first encryptor uses a different encryption algorithm than the second encryptor. In some aspects, the at least one circuit is further configured to perform one or more operations including receiving, from the memory media, the encrypted data; decrypting the encrypted data, using the decryptor, as decrypted data; and sending the decrypted data. In some aspects, the at least one circuit further includes a configuration module; and the at least one circuit is further configured to perform one or more operations including determining an encryption algorithm for the encryptor and decryptor; and applying the encryption algorithm to the at least a portion of data. In some aspects, the at least one circuit is further configured to perform one or more operations including determining that the at least a portion of data should be encrypted; and enabling the encryptor to encrypt the data based on determining that the at least a portion of data should be encrypted. In some aspects, receiving at least a portion of data includes receiving the at least a portion of data during at least one of a flush of cache data or an application flush from device memory to the storage media.

In some aspects, the techniques described herein relate to a method including receiving at least a portion of data, the at least a portion of data being received based on at least one of a flush of cache data and an application flush from device memory to storage media; encrypting the at least a portion of data as encrypted data; and storing, to the storage media, the encrypted data. In some aspects, the method further includes receiving, from the storage media, the encrypted data; decrypting the encrypted data as decrypted data; and sending the decrypted data. In some aspects, the method further includes determining an encryption algorithm; and applying the encryption algorithm to the at least a portion of data. In some aspects, encrypting the at least a portion of data includes encrypting the at least a portion of data using a first encryptor; the at least a portion of data is first data; the encrypted data is first encrypted data; and the method further includes receiving second data; encrypting, using a second encryptor, the second data as second encrypted data; and storing, to memory media, the second encrypted data. In some aspects, encrypting the at least a portion of data includes encrypting the at least a portion of data using a first encryptor; memory media is configured to receive second encrypted data from a second encryptor; and the first encryptor uses a different encryption algorithm than the second encryptor. In some aspects, the method further includes receiving, from the storage media, the encrypted data; decrypting the encrypted data as decrypted data; and sending the decrypted data.

In some aspects, the techniques described herein relate to a system including a host device including device memory; and a memory device including at least one circuit, memory media, storage media, encryptor, and decryptor; and the at least one circuit is configured to perform one or more operations including receiving, from the device memory, at least a portion of data; encrypting, using the encryptor, the at least a portion of data as encrypted data; and storing, to the storage media, the encrypted data. In some aspects, the at least one circuit is further configured to perform one or more operations including receiving, from the storage media, the encrypted data; decrypting, using the decryptor, the encrypted data as decrypted data; and sending, to the device memory, the decrypted data. In some aspects, the encryptor is a first encryptor; the decryptor is a first decryptor; the at least a portion of data is first data; the at least one circuit further includes a second encryptor and a second decryptor; and the at least one circuit is further configured to perform one or more operations including receiving from the device memory, second data; encrypting, using the first encryptor, the second data as second encrypted data; and storing, to the memory media, the second encrypted data. In some aspects, the at least one circuit is further configured to perform one or more operations including receiving, from the memory media, second encrypted data; decrypting, using the decryptor, the second encrypted data as decrypted data; and sending, to the device memory, the decrypted data. In some aspects, encrypting the at least a portion of data includes encrypting the at least a portion of data using a first encryptor; the memory media is configured to receive second encrypted data from a second encryptor; and the first encryptor uses a different encryption algorithm than the second encryptor.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an embodiment of a memory device scheme in accordance with example embodiments of the disclosure.

FIG. 2 illustrates another embodiment of a memory device scheme in accordance with embodiments of the disclosure.

FIG. 3 illustrates an example operating environment in accordance with embodiments of the disclosure.

FIG. 4 illustrates another example operating environment in accordance with embodiments of the disclosure.

FIG. 5 illustrates a flowchart of a method of securing data in accordance with embodiments of the disclosure.

### DETAILED DESCRIPTION

Generally, memory media (e.g., cache media) may be used to temporarily store data. Cache media may be characterized as volatile media, where the cache media loses its data when power is no longer supplied to the media. For example, when a computing device is shut down (e.g., external power is no longer provided to the cache media), the data in the cache media may not be retained. To preserve the data, the data in the cache media may be written to storage media, which may retain data even when the computing device is shut down (e.g., data remains in the storage media when external power is not being supplied to the storage media).

A host may wish to protect the data from the cache media (e.g., cache data) from unwanted access when the data is retained, e.g., in the storage media. However, in some embodiments, a memory device may not have a way to protect (e.g., encrypt) the cache data when the data is written to the storage media. Various solutions may be provided to encrypt the data on the memory device. For example, in some embodiments, a user-based encryption, e.g., on a host, may be used to encrypt the data. However, user-based encryption may incur large latency overhead when encrypting/decrypting the data (e.g., a central processing unit (CPU) on the host may execute the encryption/decryption operations otherwise preventing it from executing other operations). In some embodiments, a CPU-based technology to encrypt/decrypt the data may be used. However, this solution may also incur latency overhead since all data coming from/going to the memory device may be encrypted. Furthermore, some CPU-based technologies to encrypt/decrypt data may only be configured during the boot process.

According to embodiments of the invention, one or more encryption/decryption engines may be added to the memory device. In some embodiments, data transferred between the cache media and the storage media (e.g., during a flush of cache data, e.g., a global persistent flush (GPF), or when flushing application data) may be encrypted/decrypted. In some embodiments, extra latency overhead for regular load/store operations may not be added between the host and memory device.

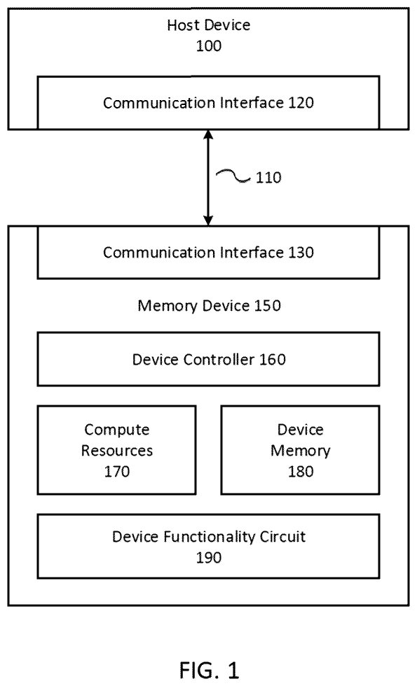

FIG. 1 illustrates an embodiment of a memory device scheme in accordance with example embodiments of the disclosure. The embodiment illustrated in FIG. 1 may include one or more host devices 100 and one or more memory devices 150 configured to communicate using one or more communication connections 110.

In some embodiments, a host device 100 may be implemented with any component or combination of components that may utilize one or more features of a memory device 150. For example, a host may be implemented with one or more of a server, a storage node, a compute node, a central processing unit (CPU), a workstation, a personal computer, a tablet computer, a smartphone, and/or the like, or multiples and/or combinations thereof.

In some embodiments, a memory device 150 may include a communication interface 130, memory 180 (some or all of which may be referred to as device memory), one or more compute resources 170 (which may also be referred to as computational resources), a device controller 160, and/or a device functionality circuit 190. In some embodiments, the device controller 160 may control the overall operation of the memory device 150 including any of the operations, features, and/or the like, described herein. For example, in some embodiments, the device controller 160 may parse, process, invoke, and/or the like, commands received from the host devices 100.

In some embodiments, the device functionality circuit 190 may include any hardware to implement the primary function of the memory device 150. For example, the device functionality circuit 190 may include storage media such as magnetic media (e.g., if the memory device 150 is implemented as a hard disk drive (HDD) or a tape drive), solid state media (e.g., one or more flash memory devices), optical media, and/or the like, For instance, in some embodiments, a memory device may be implemented at least partially as a solid-state drive (SSD) based on not-AND (NAND) flash memory, persistent memory (PMEM) such as cross-gridded nonvolatile memory, memory with bulk resistance change, phase change memory (PCM), or any combination thereof. In some embodiments, the device controller 160 may include a media translation layer such as a flash translation layer (FTL) for interfacing with one or more flash memory devices. In some embodiments, the memory device 150 may be implemented as a computational storage drive, a computational storage processor (CSP), and/or a computational storage array (CSA).

As another example, if the memory device 150 is implemented as an accelerator, the device functionality circuit 190 may include one or more accelerator circuits, memory circuits, and/or the like.

The compute resources 170 may be implemented with any component or combination of components that may perform operations on data that may be received, stored, and/or generated at the memory device 150. Examples of compute engines may include combinational logic, sequential logic, timers, counters, registers, state machines, complex programmable logic devices (CPLDs), field programmable gate arrays (FPGAs), application specific integrated circuits (ASICs), embedded processors, microcontrollers, central processing units (CPUs) such as complex instruction set computer (CISC) processors (e.g., x86 processors) and/or a reduced instruction set computer (RISC) processors such as ARM processors, graphics processing units (GPUs), data processing units (DPUs), neural processing units (NPUs), tensor processing units (TPUs), and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

In some embodiments, the memory 180 may be used, for example, by one or more of the compute resources 170 to store input data, output data (e.g., computation results), intermediate data, transitional data, and/or the like. The memory 180 may be implemented, for example, with volatile memory such as dynamic random-access memory (DRAM), static random-access memory (SRAM), and/or the like, as well as any other type of memory such as nonvolatile memory.

In some embodiments, the memory 180 and/or compute resources 170 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in a repository in memory 180 and/or compute resources 170. In some embodiments, software, instructions, programs, code, and/or the like, may be downloaded, uploaded, sideloaded, pre-installed, built-in, and/or the like, to the memory 180 and/or compute resources 170. In some embodiments, the memory device 150 may receive one or more instructions, commands, and/or the like, to select, enable, activate, execute, and/or the like, software, instructions, programs, code, and/or the like. Examples of computational operations, functions, and/or the like, that may be implemented by the memory 180, compute resources 170, software, instructions, programs, code, and/or the like, may include any type of algorithm, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for artificial intelligence (AI), machine learning (ML), neural networks, and/or the like.

In some embodiments, a communication interface 120 at a host device 100, a communication interface 130 at a memory device 150, and/or a communication connection 110 may implement, and/or be implemented with, one or more interconnects, one or more networks, a network of networks (e.g., the internet), and/or the like, or a combination thereof, using any type of interface, protocol, and/or the like. For example, the communication connection 110, and/or one or more of the interfaces 120 and/or 130 may implement, and/or be implemented with, any type of wired and/or wireless communication medium, interface, network, interconnect, protocol, and/or the like including Peripheral Component Interconnect Express (PCIe), NVMe, NVMe over Fabric (NVMe-oF), Compute Express Link (CXL), and/or a coherent protocol such as CXL.mem, CXL.cache, CXL.io and/or the like, Gen-Z, Open Coherent Accelerator Processor Interface (OpenCAPI), Cache Coherent Interconnect for Accelerators (CCIX), and/or the like, Advanced extensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), FibreChannel, InfiniBand, Serial ATA (SATA), Small Computer Systems Interface (SCSI), Serial Attached SCSI (SAS), iWARP, any generation of wireless network including 2G, 3G, 4G, 5G, 6G, and/or the like, any generation of Wi-Fi, Bluetooth, near-field communication (NFC), and/or the like, or any combination thereof. In some embodiments, a communication connection 110 may include one or more switches, hubs, nodes, routers, and/or the like,

In some embodiments, a memory device 150 may be implemented in any physical form factor. Examples of form factors may include a 3.5 inch, 2.5 inch, 1.8 inch, and/or the like, memory device (e.g., storage drive) form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCIe card (e.g., PCIe expansion card) form factor including half-height (HH), half-length (HL), half-height, half-length (HHHL), and/or the like), Next-generation Small Form Factor (NGSFF), NFI form factor, compact flash (CF) form factor, secure digital (SD) card form factor, Personal Computer Memory Card International Association (PCMCIA) device form factor, and/or the like, or a combination thereof. Any of the computational devices disclosed herein may be connected to a system using one or more connectors such as SATA connectors, SCSI connectors, SAS connectors, M.2 connectors, EDSFF connectors (e.g., 1C, 2C, 4C, 4C+, and/or the like), U.2 connectors (which may also be referred to as SSD form factor (SSF) SFF-8639 connectors), U.3 connectors, PCIe connectors (e.g., card edge connectors), and/or the like.

Any of the memory devices disclosed herein may be used in connection with one or more personal computers, smart phones, tablet computers, servers, server chassis, server racks, datarooms, datacenters, edge datacenters, mobile edge datacenters, and/or any combinations thereof.

In some embodiments, a memory device 150 may be implemented with any device that may include, or have access to, memory, storage media, and/or the like, to store data that may be processed by one or more compute resources 170. Examples may include memory expansion and/or buffer devices such as CXL type 2 and/or CXL type 3 devices, as well as CXL type 1 devices that may include memory, storage media, and/or the like.

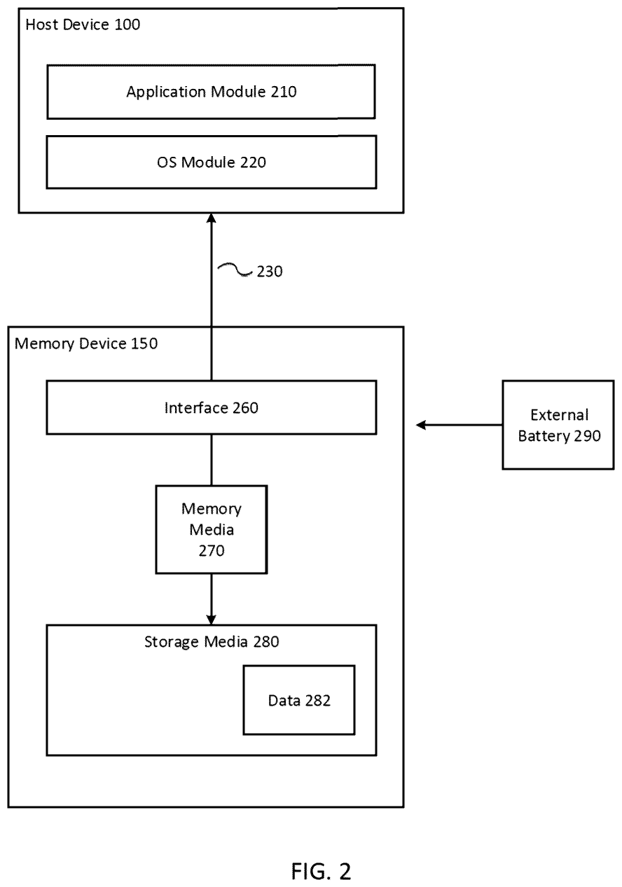

FIG. 2 illustrates another embodiment of a memory device scheme in accordance with example embodiments of the disclosure. The elements illustrated in FIG. 2 may be similar elements to those illustrated in FIG. 1 in which similar elements may be indicated by reference numbers ending in, and/or containing, the same digits, letters, and/or the like. In some embodiments, the host device 100 may include an application module 210 and operating system (OS) module 220; and the memory device 150 may include an interface 260, memory media 270 (e.g., cache media), and/or storage media 280. In some embodiments, the interface 260 may be the interface 120 in FIG. 1 or some other interface that allows the memory device 150 to communicate with the host device 100. In some embodiments, the interface 260 may be implemented on one or more circuits of the memory device 150. In some embodiments, the one or more circuits may include one or more FPGAs, ASICs, and/or SOCs.

In some embodiments, the memory media 270 may be relatively fast memory such as DRAM and the storage media 280 may be slower non-volatile memory, such as NAND flash memory. In some embodiments, the memory media 270 may be used as a cache to store frequently accessed data in the faster memory. In some embodiments, the application module 210 may use a memory access request to send/retrieve data from the memory media 270. For example, in some embodiments, in response to receiving a memory access request, the memory device 150 may check the memory media 270 for data corresponding to the request. In some embodiments, in response to a cache hit (e.g., the data is found on the memory media 270), the data may be returned from the memory media 270. In some embodiments, in response to a cache miss (e.g., the data is not found on the memory media 270), the memory device 150 may copy the data from the storage media 280 to the memory media 270 and return the data from the memory media 270. In some embodiments, the memory device 150 may be advertised as system memory. In other words, the memory device 150 may appear to the host device 100 as an additional memory node and may be managed by the OS non-uniform memory architecture (NUMA) memory management.

In some embodiments, the OS module 220 may send data to or receive data from the memory device 150. For example, the OS may use the memory device 150 as expanded memory and/or write cache data to the memory media 270. For example, when the memory device 150 is configured as expanded memory, the host device 100 may write cache data to local device memory on the host device 100 or on the memory device 150. In some embodiments, since the memory device 150 may use memory media 270, with its fast speed, the host device 100 may not experience a lot of latency when accessing the memory media 270 as compared to accessing local device memory. In some embodiments, this may offer the host device 100 additional memory capacity at a lower cost than adding additional device memory to the host device host device 100.

In some embodiments, the memory device 150 may be coupled to an external battery 290. In some embodiments, the external battery 290 may supply power to the memory device 150 so that data (such as data 282) may be retained in the memory media 270 (e.g., memory media 270 may require a power source to retain data).

In some embodiments, the host device 100 may provide additional ways to encrypt data (e.g., a CPU-based encryption scheme may be run from the OS module 220). For example, the host device 100 may have a way to encrypt data as it is being written to the memory device 150. However, the CPU may need to run operations to perform the encryption (thereby preventing the CPU from performing other operations). In some embodiments, the host device 100 may run an application to perform encryption. However, this may add additional latency to the operations of the host device 100.

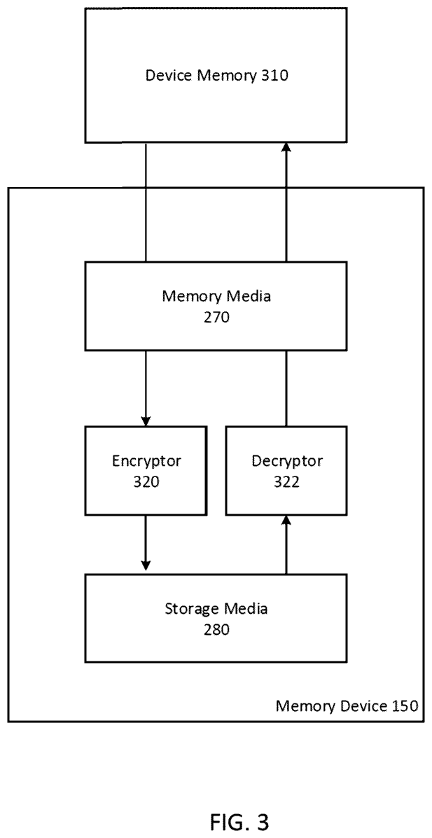

FIG. 3 illustrates an example operating environment in accordance with embodiments of the disclosure. The elements illustrated in FIG. 3 may be similar elements to those illustrated in FIGS. 1 and 2 in which similar elements may be indicated by reference numbers ending in, and/or containing, the same digits, letters, and/or the like. In some embodiments, the memory device 150 may include encryptor 320 and decryptor 322. In some embodiments, a host device, such as the host device 100, may include device memory 310. In some embodiments, the device memory 310 may be on the memory device 150 (e.g., the memory media 270). In some embodiments, the device memory 310 may store cache data. In some embodiments, as the cache data is written to the storage media 280 (e.g., to retain data when the computing system is powered off), the encryptor 320 may encrypt the data. Thus, in some embodiments, the storage media 280 may store encrypted data. In some embodiments, since the encryptor 320 is on the memory device 150, the host device may be free to perform other operations. In some embodiments, when the encrypted data is retrieved from the storage media 280, the data may be decrypted by the decryptor 322. Thus, the host may not need to decrypt the data when retrieving the data from the storage media 280.

In some embodiments, the encryptor 320 may be used to encrypt data. For example, data may be received by the encryptor 320 as text. If a host has access to the data, the data may be viewable. In some embodiments, if the encryptor 320 encrypts the data, the data may not be viewable exempt by using, e.g., a key. In some embodiments, if a host attempts to access the encrypted data without a key, the data may not appear in usable format. In some embodiments, the encryptor 320 may be hardware, e.g., on one or more circuit of the memory device 150, or may be software. In some embodiments, the encryptor 320 may be implemented one or more FPGAs, ASICs, and/or SOCs.

In some embodiments, the decryptor 322 may be used to decrypt data. For example, data may be received by the decryptor 322 as encrypted text. If a host has access to the data, the data may not appear in a usable format. When the data is sent to the decryptor 322, it may be output as text. In some embodiments, the decryptor 322 may be hardware, e.g., on one or more circuits of the memory device 150, or may be software. In some embodiments, the decryptor 322 may be implemented one or more FPGAs, ASICs, and/or SOCs.

In some embodiments, the encryptor 320 and/or decryptor 322 may be capable of using various encryption/decryption algorithms. For example, the encryptor 320 and/or decryptor 322 may be configured to use DES (data encryption standard), AES (advanced encryption system), and/or any other algorithm used for encryption/decryption. In some embodiments, an encryption/decryption algorithm may be selected based on security, speed, or any other factor. For example, when writing to the memory media 270, since the read/write speed may be fast, a faster algorithm may be preferred. Thus, the encryptor 320 may be configured to use a faster algorithm when encrypting cache data. In some embodiments, one encryption/decryption algorithm may be used for a portion of data, and another encryption/decryption algorithm used for a different portion of data. In some embodiments, different encryption/decryption algorithms may be used for the same data. For example, when writing to the memory media 270, one encryption/decryption algorithm may be used and when writing to the storage media 280, another encryption/decryption algorithm may be used.

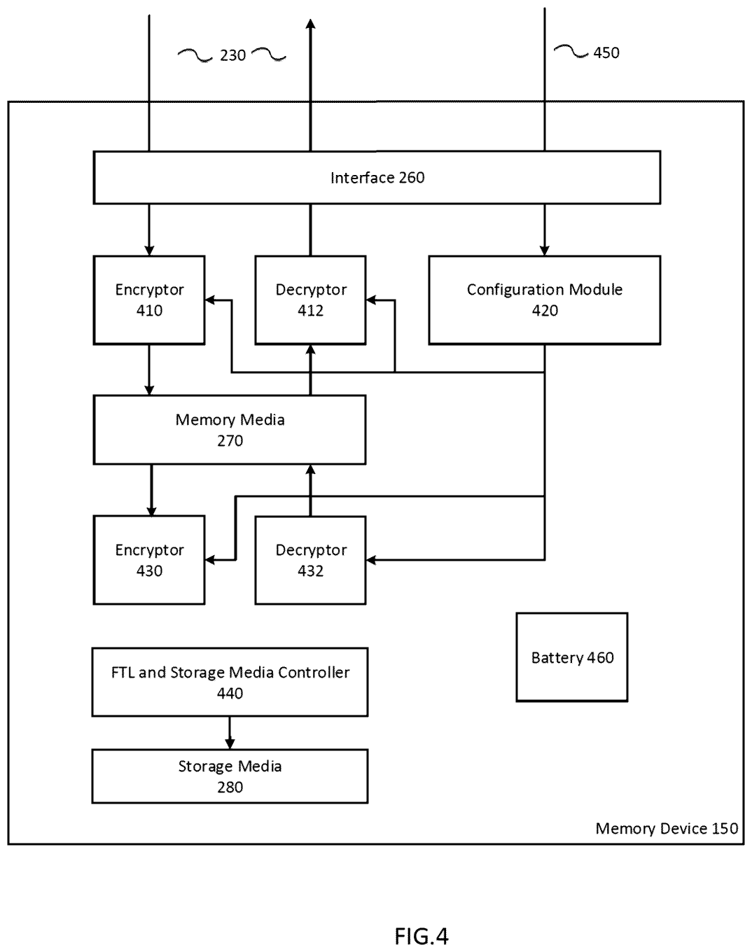

FIG. 4 illustrates another example operating environment in accordance with embodiments of the disclosure. The elements illustrated in FIG. 4 may be similar elements to those illustrated in FIGS. 1, 2 and 3 in which similar elements may be indicated by reference numbers ending in, and/or containing, the same digits, letters, and/or the like. memory device 150 may include encryptors 410 and 430, decryptors 412 and 432, configuration module 420, FTL and storage media controller 440, and/or battery 460. In some embodiments, the battery 460 may provide power to the storage media 280 so that when external power is no longer provided to the memory device 150, the storage media 280 may still retain data. In some embodiments, any of the encryptors 410 and 430, decryptors 412 and 432, and/or configuration module 420 may be configured on one or more circuits on the memory device 150. In some embodiments, data received from a host and written to the memory media 270 may be encrypted using the encryptor 410. In some embodiments, a host may set an encryption algorithm using the configuration module 420. In some embodiments, the configuration module 420 may use an encryption scheme based on speed versus security considerations. For example, for data that may be less secure, the host may select an encryption scheme with fast performance. If the host would like more security, in some embodiments, the host may select an encryption scheme with greater security but may not perform as fast as a fast encryption scheme. In some embodiments, since the encryption is performed by the memory device 150, the host may not need to use computing resources to encrypt the data, thus saving computing resources on the host. Furthermore, since the memory device 150 may perform the encryption independent of operations from the host, the latency may be minimized.

In some embodiments, when data is read from the memory media 270, the memory device 150 may use the decryptor 412 to decrypt the data before sending it to the host. The encryptor 410 and decryptor 412 may use the same encryption scheme as set by the configuration module 420. In some embodiments, the encryption scheme may be set for a session. For example, for a given session, the encryptor 410 and decryptor 412 may use the same encryption scheme. Thus, additional information may not be necessary for the decryptor 412 to know what encryption scheme was used to encrypt the data. In some embodiments, the configuration module 420 may keep track of what encryption scheme was used for which data and supply that information to the decryptor 412 to decrypt the data. In some embodiments, the data may have an indicator indicating the encryption scheme so that the decryptor 412 may know how to decrypt the data.

In some embodiments, data written to the storage media 280 may be encrypted using the encryptor 430. In some embodiments, the memory device 150 may distinguish operations where the memory device 150 may be used as expanded memory, and operation where the memory device 150 may be used to store data. In some embodiments, only data transferred between the device local memory and the storage media 280 (e.g., during a flush of cache data, e.g., global persistent flush (GPF) data dump, or when flushing application data to the persistent domain) may be encrypted. For example, when data is written to the memory device 150, the data may not be written to the storage media 280 and instead stored in the memory media 270. In some embodiments, when a power loss to the system occurs, some of the data in the local memory and the memory media 270 may be written to the storage media 280 to preserve the data. In some embodiments, the host and/or memory device 150 may perform the transfer of data to the storage media 280 even during a power loss.

In some embodiments, when data is read from the storage media, the data may be decrypted using the decryptor 432. For example, the configuration module 420 may indicate to the decryptor 432 an encryption algorithm to use to decrypt the data. The decrypted data may be sent to a host. For example, if a host wishes to resume operation, e.g., after a shut down, it may not be able to resume where it left off if the data in the device memory is not retained. By storing the data in the memory device, the host may resume operation when the data is stored on the memory device. When the data is being stored, encrypting the data may secure the data so that other hosts and/or unwanted actors may not have access to the data on the memory device.

In some embodiments, the data may be encrypted when being written to the memory media 270 and when being written to the storage media 280. In some embodiments data may be encrypted only when being written to the storage media 280. In some embodiments, the encryptor 410 and encryptor 430 may use different encryption schemes.

In some embodiments, the configuration module 420 may be configurable by the host. In some embodiments, the host may select an algorithm for the encryptor 410 and decryptor 412, and/or the encryptor 430 and decryptor 432. For example, during the data backup stage during flushing of cache data or an application flushing data to the storage media 280, the encryptor 410 and/or encryptor 430 may encrypt the data using an encryption algorithm, such as Advanced Encryption Standard (AES). It should be understood that any encryption algorithm may be used and future encryption algorithms may be added as needed. In some embodiments, the encryptor 410 and encryptor 430 may use different encryption schemes. For example, since the memory media 270 may be relatively fast, the host may choose an encryption scheme that minimizes latency, such as a lightweight encryption scheme. In some embodiments, since the storage media 280 may be slower than the memory media 270, the host may choose a stronger encryption scheme. In some embodiments, the host may be able to enable/disable the encryptor 410 and decryptor 412, and/or the encryptor 430 and decryptor 432. For example, the host may determine that it does not want increased latency from encrypting to the memory media 270 and may disable encrypting/decryption from the encryptor 410 and decryptor 412. This determination may be performed on a process basis, application basis, duration basis, or any other basis that allows the host to distinguish which data it may determine the encrypt and decrypt.

In some embodiments, the configuration module 420 may use a different memory access protocol 450 (e.g., CXL.io) than the memory access protocol 230 (e.g., CXL.mem) used to communicate with the memory media 270 and storage media 280. For example, the memory access protocol 230 may be used for load/store commands to the memory device 150, and the memory access protocol 450 may be used for configuration commands among others.

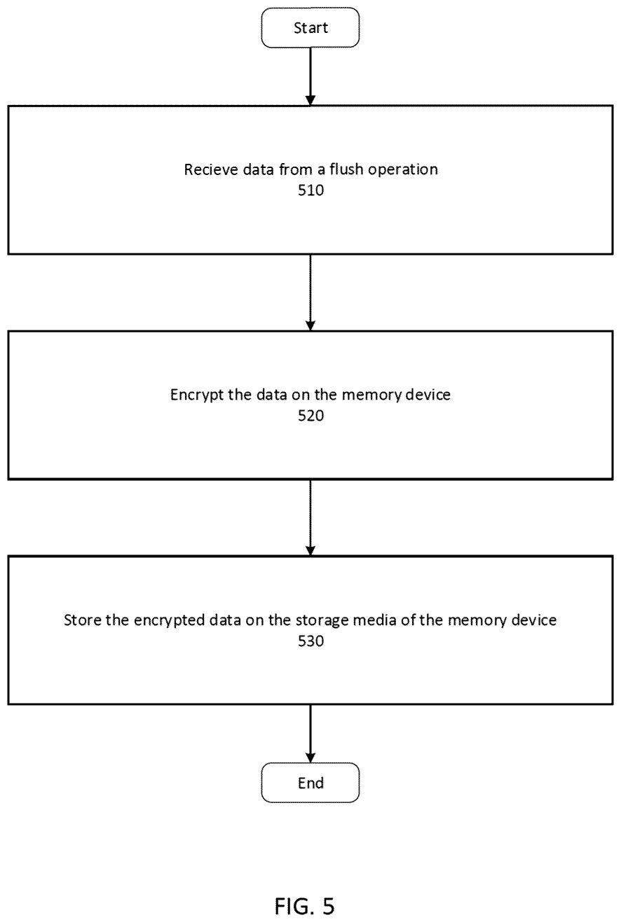

FIG. 5 illustrates a flowchart of a method of securing data in accordance with embodiments of the disclosure. The following description may be applied to the memory device 150 in FIGS. 1-4. Where there are differences, the descriptions will identify which figure the description is applied.

At 510, data may be received from a flush operation. For example, storage media, such as the storage media 280, may receive data, e.g., from a host. In some embodiments, the data from may be received from the device memory of the host. In some embodiments, the host may use the memory media 270 on the memory device 150, and pass the data to the storage media 280. In some embodiments, data may be received from a global persistent flush (GPF) and/or an application flush from the device memory to the storage media 280.

At 520, the data may be encrypted on the memory device. For example, the configuration module 420 may be set to encrypt data from the device memory and may set an encryption algorithm to use for an encryptor. As data is coming from the host and/or memory media, the encryptor may apply the encryption algorithm to the data. In some embodiments, the encryption algorithm may be per process, per operation, or any other way to separate the data received by the memory device. For example, if the memory device is attached to multiple virtual machines, each virtual machine may use its own encryption algorithm. In some embodiments, the configuration module 420 may identify the data being written and determine whether to encrypt the data and/or which encryption algorithm to apply to the data. In some embodiments, the encryption may be performed independently of the host operations, and thus latency may not be incurred (e.g., the host may not allocate processes to encrypt/decrypt the data and the data may be encrypted/decrypted on the memory device).

At 530, the encrypted data may be stored on the storage media on the memory device. Since the data may be encrypted, the data is protected from access from other hosts or other unwanted access. Furthermore, since the configuration module may keep track of the encryption algorithm, the data may be decrypted when returned to the host.

This disclosure encompasses numerous aspects relating to devices with memory and storage configurations. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

In some embodiments, cache media may be accessed by software using load and/or store instructions, whereas storage media may be accessed by software using read and/or write instructions.

In some embodiments, cache media may be accessed using a memory interface and/or protocol such as double data rate (DDR) of any generation (e.g., DDR4, DDR5, etc.), DMA, RDMA, Open Memory Interface (OMI), CXL, Gen-Z, and/or the like, whereas storage media may be accessed using a storage interface and/or protocol such as serial ATA (SATA), Small Computer System Interface (SCSI), serial attached SCSI (SAS), NVMe, NVMe-oF, and/or the like.

Although some embodiments may be described in the context of cache media that may be implemented with cache media such as DRAM, in other embodiments, other types of media, e.g., storage media, may be used for cache media. For example, in some embodiments, some or all of the memory media 270 may be implemented with media other than cache media that may have one or more relative characteristics (e.g., relative to the storage media 280) that may make one or both of them more suitable for their respective functions. For instance, in some embodiments, the storage media 280 may have a relatively higher capacity, lower cost, and/or the like, whereas some or all of the memory media 270 may have relatively lower access latency that may make it relatively more suitable for use as a cache.

Memory device 150 as well as any other devices disclosed herein may be used in connection with one or more personal computers, smart phones, tablet computers, servers, server chassis, server racks, datarooms, datacenters, edge datacenters, mobile edge datacenters, and/or any combinations thereof.

Any of the functionality described herein, including any of the user functionality, device functionally, and/or the like (e.g., any of the control logic) may be implemented with hardware, software, firmware, or any combination thereof including, for example, hardware and/or software combinational logic, sequential logic, timers, counters, registers, state machines, volatile memories such DRAM and/or SRAM, nonvolatile memory including flash memory, persistent memory such as cross-gridded nonvolatile memory, memory with bulk resistance change, PCM, and/or the like and/or any combination thereof, complex programmable logic devices (CPLDs), FPGAs, ASICS, central processing units (CPUs) including CISC processors such as x86 processors and/or RISC processors such as ARM processors, graphics processing units (GPUs), neural processing units (NPUs), tensor processing units (TPUs), data processing units (DPUs), and/or the like, executing instructions stored in any type of memory. In some embodiments, one or more components may be implemented as a system on a chip (SoC).

Some embodiments disclosed above have been described in the context of various implementation details such as devices implemented as memory devices that may use specific interfaces, protocols, and/or the like, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

In some embodiments, a portion of an element may refer to less than, or all of, the element. A first portion of an element and a second portion of the element may refer to the same portions of the element. A first portion of an element and a second portion of the element may overlap (e.g., a portion of the first portion may be the same as a portion of the second portion).

In the embodiments described herein, the operations are example operations, and may involve various additional operations not explicitly illustrated. In some embodiments, some of the illustrated operations may be omitted. In some embodiments, one or more of the operations may be performed by components other than those illustrated herein. Additionally, in some embodiments, the temporal order of the operations may be varied. Moreover, the figures are not necessarily drawn to scale.

The principles disclosed herein may have independent utility and may be embodied individually, and not every embodiment may utilize every principle. However, the principles may also be embodied in various combinations, some of which may amplify the benefits of the individual principles in a synergistic manner.

In some embodiments, the latency of a memory device may refer to the delay between a memory device and the processor in accessing memory. Furthermore, latency may include delays caused by hardware such as the read-write speeds to access a memory device, and/or the structure of an arrayed memory device producing individual delays in reaching the individual elements of the array. For example, a first memory device in the form of DRAM may have a faster read/write speed than a second memory device in the form of a NAND device. Furthermore, the latency of a memory device may change over time based on conditions such as the relative network load, as well as performance of the memory device over time, and environmental factors such as changing temperature influencing delays on the signal path.

Although some example embodiments may be described in the context of specific implementation details such as a processing system that may implement a NUMA architecture, memory devices, and/or pools that may be connected to a processing system using an interconnect interface and/or protocol CXL, and/or the like, the principles are not limited to these example details and may be implemented using any other type of system architecture, interfaces, protocols, and/or the like. For example, in some embodiments, one or more memory devices may be connected using any type of interface and/or protocol including Peripheral Component Interconnect Express (PCIe), Nonvolatile Memory Express (NVMe), NVMe-over-fabric (NVMe oF), Advanced extensible Interface (AXI), Ultra Path Interconnect (UPI), Ethernet, Transmission Control Protocol/Internet Protocol (TCP/IP), remote direct memory access (RDMA), RDMA over Converged Ethernet (ROCE), FibreChannel, InfiniBand, Serial ATA (SATA), Small Computer Systems Interface (SCSI), Serial Attached SCSI (SAS), iWARP, and/or the like, or any combination thereof. In some embodiments, an interconnect interface may be implemented with one or more memory semantic and/or memory coherent interfaces and/or protocols including one or more CXL protocols such as CXL.mem, CXL.io, and/or CXL.cache, Gen-Z, Coherent Accelerator Processor Interface (CAPI), Cache Coherent Interconnect for Accelerators (CCIX), and/or the like, or any combination thereof. Any of the memory devices may be implemented with one or more of any type of memory device interface including DDR, DDR2, DDR3, DDR4, DDR5, LPDDRX, Open Memory Interface (OMI), NVLink, High Bandwidth Memory (HBM), HBM2, HBM3, and/or the like.

In some embodiments, any of the memory devices, memory pools, hosts, and/or the like, or components thereof, may be implemented in any physical and/or electrical configuration and/or form factor such as a free-standing apparatus, an add-in card such as a PCIe adapter or expansion card, a plug-in device, for example, that may plug into a connector and/or slot of a server chassis (e.g., a connector on a backplane and/or a midplane of a server or other apparatus), and/or the like, In some embodiments, any of the memory devices, memory pools, hosts, and/or the like, or components thereof, may be implemented in a form factor for a memory device such as 3.5 inch, 2.5 inch, 1.8 inch, M.2, Enterprise and Data Center SSD Form Factor (EDSFF), NF1, and/or the like, using any connector configuration for the interconnect interface such as a SATA connector, SCSI connector, SAS connector, M.2 connector, U.2 connector, U.3 connector, and/or the like. Any of the devices disclosed herein may be implemented entirely or partially with, and/or used in connection with, a server chassis, server rack, dataroom, datacenter, edge datacenter, mobile edge datacenter, and/or any combinations thereof. In some embodiments, any of the memory devices, memory pools, hosts, and/or the like, or components thereof, may be implemented as a CXL Type-1 device, a CXL Type-2 device, a CXL Type-3 device, and/or the like.

In some embodiments, any of the functionality described herein, including, for example, any of the logic to implement tiering, device selection, and/or the like, may be implemented with hardware, software, or a combination thereof including combinational logic, sequential logic, one or more timers, counters, registers, and/or state machines, one or more CPLD, FPGA, ASICs, CPU such as CISC processors such as x86 processors and/or RISC processors such as ARM processors, GPUs, NPUs, TPUs and/or the like, executing instructions stored in any type of memory, or any combination thereof. In some embodiments, one or more components may be implemented as a system-on-chip (SOC).

In this disclosure, numerous specific details are set forth in order to provide a thorough understanding of the disclosure, but the disclosed aspects may be practiced without these specific details. In other instances, well-known methods, procedures, components, and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” may include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

The term “module” may refer to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system-on-a-chip (SoC), an assembly, and so forth. Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, e.g., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable memory device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other memory devices). Additionally, the operations described in this specification may be implemented as operations performed by a data-processing apparatus on data stored on one or more computer-readable memory devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

While certain exemplary embodiments have been described and shown in the accompanying drawings, it should be understood that such embodiments merely illustrative, and the scope of this disclosure is not limited to the embodiments described or illustrated herein. The invention may be modified in arrangement and detail without departing from the inventive concepts, and such changes and modifications are considered to fall within the scope of the following claims.

1. A device comprising:
at least one circuit comprising an encryptor and a decryptor;
memory media; and
storage media, wherein the encryptor and decryptor are configured between the memory media and storage media;
wherein the at least one circuit is configured to perform one or more operations comprising:
receiving at least a portion of data;
encrypting, using the encryptor, the at least a portion of data as encrypted data; and
storing, to the storage media, the encrypted data.

2. The device of claim 1, wherein the at least one circuit is further configured to perform one or more operations comprising:
receiving, from the storage media, the encrypted data;
decrypting, using the decryptor, the encrypted data as decrypted data; and
sending the decrypted data.

3. The device of claim 1,
wherein the encryptor is a first encryptor;
wherein the decryptor is a first decryptor;
wherein the at least a portion of data is first data;
wherein the at least one circuit further comprises a second encryptor and a second decryptor; and
wherein the at least one circuit is further configured to perform one or more operations comprising:
receiving second data;
encrypting, using the second encryptor, the second data as second encrypted data; and
storing, to the memory media, the second encrypted data.

4. The device of claim 1,
wherein the at least one circuit is further configured to perform one or more operations comprising:
receiving, from the memory media, second encrypted data;
encrypting, using the encryptor, the second encrypted data as third encrypted data; and
storing, to the storage media, the third encrypted data.

5. The device of claim 1,
wherein the encryptor is a first encryptor;
wherein the encrypted data is first encrypted data;
wherein the memory media is configured to receive second encrypted data from a second encryptor; and
wherein the first encryptor uses a different encryption algorithm than the second encryptor.

6. The device of claim 1,
wherein the at least one circuit is further configured to perform one or more operations comprising:
receiving, from the memory media, the encrypted data;
decrypting the encrypted data, using the decryptor, as decrypted data; and
sending the decrypted data.

7. The device of claim 1,
wherein the at least one circuit further comprises a configuration module; and
wherein the at least one circuit is further configured to perform one or more operations comprising:
determining an encryption algorithm for the encryptor and decryptor; and
applying the encryption algorithm to the at least a portion of data.

8. The device of claim 7,
wherein the at least one circuit is further configured to perform one or more operations comprising:
determining that the at least a portion of data should be encrypted; and
enabling the encryptor to encrypt the data based on determining that the at least a portion of data should be encrypted.

9. The device of claim 1, wherein receiving at least a portion of data comprises:
receiving the at least a portion of data during at least one of a flush of cache data or an application flush from device memory to the storage media.

10. A method comprising:
receiving at least a portion of data, the at least a portion of data being received based on at least one of a flush of cache data and an application flush from device memory to storage media;
encrypting the at least a portion of data as encrypted data; and
storing, to the storage media, the encrypted data.

11. The method of claim 10, further comprising:
receiving, from the storage media, the encrypted data;
decrypting the encrypted data as decrypted data; and
sending the decrypted data.

12. The method of claim 10, further comprising:
determining an encryption algorithm; and
applying the encryption algorithm to the at least a portion of data.

13. The method of claim 10,
wherein encrypting the at least a portion of data comprises encrypting the at least a portion of data using a first encryptor;
wherein the at least a portion of data is first data;
wherein the encrypted data is first encrypted data; and
wherein the method further comprises:
receiving second data;
encrypting, using a second encryptor, the second data as second encrypted data; and
storing, to memory media, the second encrypted data.

14. The method of claim 10,
wherein encrypting the at least a portion of data comprises encrypting the at least a portion of data using a first encryptor;
wherein memory media is configured to receive second encrypted data from a second encryptor; and
wherein the first encryptor uses a different encryption algorithm than the second encryptor.

15. The method of claim 10, further comprising:
receiving, from the storage media, the encrypted data;
decrypting the encrypted data as decrypted data; and
sending the decrypted data.

16. A system comprising:
a host device comprising device memory; and
a memory device comprising at least one circuit, memory media, storage media, encryptor, and decryptor;
wherein the at least one circuit is configured to perform one or more operations comprising:
receiving, from the device memory, at least a portion of data;
encrypting, using the encryptor, the at least a portion of data as encrypted data; and
storing, to the storage media, the encrypted data.

17. The system of claim 16, wherein the at least one circuit is further configured to perform one or more operations comprising:
receiving, from the storage media, the encrypted data;
decrypting, using the decryptor, the encrypted data as decrypted data; and
sending, to the device memory, the decrypted data.

18. The system of claim 16,
wherein the encryptor is a first encryptor;
wherein the decryptor is a first decryptor;
wherein the at least a portion of data is first data;
wherein the at least one circuit further comprises a second encryptor and a second decryptor; and
wherein the at least one circuit is further configured to perform one or more operations comprising:
receiving from the device memory, second data;
encrypting, using the first encryptor, the second data as second encrypted data; and
storing, to the memory media, the second encrypted data.

19. The system of claim 16,
wherein the at least one circuit is further configured to perform one or more operations comprising:
receiving, from the memory media, second encrypted data;
decrypting, using the decryptor, the second encrypted data as decrypted data; and
sending, to the device memory, the decrypted data.

20. The system of claim 16,
wherein encrypting the at least a portion of data comprises encrypting the at least a portion of data using a first encryptor;
wherein the memory media is configured to receive second encrypted data from a second encryptor; and
wherein the first encryptor uses a different encryption algorithm than the second encryptor.
